(19) United States
(12) Patent Application Publication
(10) Pub. No.: US 2014/0189751 A1
(43) Pub. Date: Jul. 3, 2014

(54) BROADBAND ASSISTED CHANNEL CHANGE

(71) Applicant: THOMSON LICENSING, (US)

(72) Inventors: Mike Scott Deiss, Zionsville, IN (US); Paul Gothard Knutson, Westfield, IN (US); Aaron Reel Bouillet, Nobelsville, IN (US)

(73) Assignee: THOMSON LICENSING, Issy de Moulineaux (FR)

(21) Appl. No.: 13/727,836

(22) Filed: Dec. 27, 2012

(51) Int. Cl. H04N 21/2665

(52) U.S. Cl. CPC H04N 21/2665
USPC 725/59

(57) ABSTRACT

A receiver reduces a time delay associated with a change between two broadcast channels by detecting an activity associated with a channel change operation and requesting, via a broadband interface, data corresponding to the newly requested broadcast channel. The broadband data corresponding to the new broadcast channel is displayed while the broadcast channel is tuned and processed by the receiver. Upon processing the broadcast channel, the displayed broadband data is replaced by the processed broadcast data.

### FIELD

The present invention relates to an improvement in broadcast channel data acquisition. Specifically, the present invention relates to a method that reduces an amount of time associated with displaying content when a broadcast channel change operation is initiated by a user.

### BACKGROUND

Conventionally, a subscriber to a cable or satellite provider accesses content using a set top box connected to a display device. Through this setup, users are offered a plurality of different channels having respective different types of content broadcast thereon. Thus, there is an ever increasing amount of content available from which a user can select for viewing. Often times, users watching one program will initiate a channel change operation by depressing a channel up or channel down button on a user interface device (e.g. remote control). The continual changing of channels is commonplace among users when searching for desired content to be displayed on a display device (e.g. TV, HDTV, etc). A drawback associated with channel surfing relates to the time it takes to tune and display newly selected content. Display of a selected channel is delayed in current generation television broadcast receivers because of the time required for the digital signal processing chain to acquire, decode, and decompress the digital signal being received by the receiver.

Various methods of improving channel change speed have been proposed. One approach decodes all broadcast channels and selects the content at the transport layer thus decreasing the time needed to display newly selected content. However, it is not practical to decode all broadcast channels received by the receiver because the dynamic range experienced at the receiver still requires separate tuners for each channel. Moreover, in terms of cable and satellite systems, while it is possible to sample and process an entire band of channels, the bandwidth and processing power necessary to decode and demodulate these channels makes this option untenable. Therefore, a need exists for a system that reduces the amount of time it takes to display content selected by a user during a broadcast receiver channel change operation. A system and method as described below remedies these and other deficiencies described hereinabove.

### SUMMARY

In one aspect of the invention, a receiver is provided for reducing a time delay associated with a change between two channels of a plurality of channels. The receiver includes a tuner coupled to a first content delivery pathway for selectively tuning to a particular channel of said plurality of channels having content data transmitted thereon. A transmission interface is coupled to a second content delivery pathway for selectively acquiring content data from a set of candidate channels from amongst said plurality of channels, the content data from the set of candidate channels being acquired in advance of a channel change operation. A decoder coupled to the tuner and the transmission interface for decoding content data received via the first content delivery pathway and content data received via the second content delivery pathway. A controller that, in response to detecting an activity associated with a channel change operation to select a new channel, requests the content data associated with the set of candidate channels from at least one content provider via the transmission interface.

In another aspect of the invention a method of reducing a time delay associated with a change between channels of a plurality of channels in a receiver is provided. The method includes providing a tuner coupled to a first content delivery pathway for selectively tuning to a particular channel of the plurality of channels having content data transmitted thereon and acquiring, in advance of a channel change operation, content data from a set of candidate channels from amongst said plurality of channels via a transmission interface coupled to a second content delivery pathway. An activity associated with a channel change operation is detected by a controller and content data associated with the set of candidate channels is requested from at least one content provider via the transmission interface.

In a further aspect of the invention, a broadcast receiver has access to not only RF channel program content, but also to broadband content that corresponds to the RF channel program content. When an RF broadcast channel change is initiated by a user, broadband content that corresponds to the newly selected RF broadcast channel provides a quick display of content to the user before the newly selected RF broadcast channel information is processed and displayed.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

### BRIEF DESCRIPTION OF THE DRAWINGS

FIG. 1 is an illustrative view of the system in accordance with an aspect of an embodiment;

FIG. 2 is a block diagram of exemplary components of an encoder in accordance with an aspect of an embodiment;

FIG. 3 is a block diagram of exemplary components of a receiver in accordance with an aspect of an embodiment;

FIG. 4 is a block diagram of exemplary components of a receiver in accordance with an aspect of an embodiment;

FIG. 5A is a block diagram of exemplary components of a decoder in accordance with an aspect of an embodiment;

FIG. 5B is a block diagram of exemplary components of a decoder in accordance with an aspect of an embodiment;

FIG. 6 is a flow diagram detailing the operation of an aspect of an embodiment; and

FIG. 7 is a flow diagram detailing the operation of an aspect of an embodiment.

### DETAILED DESCRIPTION

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

The present system advantageously implements a hybrid content delivery network that reduces an amount of time associated with displaying newly selected content (e.g. start-up time) delivered on a channel other than the channel currently being viewed. As used herein, the term “content” refers to audio-visual data that may be communicated from a first source for delivery to at least one user at a remote location. Content may be uncompressed or compressed according to any type of encoding scheme. The encoding scheme may, for example, be an MPEG compliant encoding scheme. This type of coding scheme is described for purposes of example only and content may be encoded according to any type of content encoding scheme.

The hybrid content delivery system includes a first content delivery pathway that is unidirectional. The system is able to transmit content to a plurality of users and the users are able to receive, decode and otherwise process the delivered content for display on a display device (e.g. TV, HDTV, monitor, etc). In one embodiment, the unidirectional first content delivery pathway may be a radio frequency (RF) over-the-air broadcast delivery pathway whereby content providers broadcast content for RF reception by receiving devices at a user's location. The hybrid content delivery system further includes a second content delivery pathway that enables bidirectional communication between the source of the content and at least one receiving device at the user's location. In one embodiment, the bidirectional content delivery pathway is formed from a broadband network wherein the content has been encoded, for example, using internet protocol for transmission over the broadband network. Broadband networks can be either wired cable systems or high-speed wireless systems. By encoding the content for transmission over a broadband network, a user may selectively request, acquire, process and display the same content in less time than is typically associated with receiving, decoding and demodulating the same content over the unidirectional (e/g broadcast) content delivery pathway.

The system advantageously augments and correlates the content encoded for the unidirectional content delivery pathway with the content encoded for the bidirectional content delivery pathway. The augmentation and correlation of the content allows for rapid display of the requested content via the second bidirectional communication pathway. The rapid display of content occurs because, upon registering a channel change operation at the receiver, the receiver automatically acquires the content via the bidirectional content delivery pathway enabling a faster display of the requested content as compared to the time it typically takes to receive, decode and process the same content delivered via the unidirectional content delivery pathway.

In general operation, the user selects, receives and views content via the first content delivery pathway. Upon determination by the receiving device that a channel change operation resulting in the acquisition, decoding and display of different content is imminent, the receiving unit requests a set of candidate channels wherein each channel and respective content transmitted thereon is received via the second content delivery pathway. The source of the content provides the requested set of candidate channels via the second content delivery pathway to the receiver. The receiver receives the set of candidate channels including all content associated with each channel in the set of candidate channels. Upon selection of a new channel by a user, the receiver processes the content on the selected channels and displays content to the user. Additionally, in response to selection of a new channel, the receiver also tunes a tuner to the frequency associated with the newly selected channel in order to receive content thereon via the first content delivery pathway. Due to the time associated with tuning a new channel, demodulating the newly tuned channel and decoding the content data on the new channel, data from the newly selected channel is not immediately displayable to a user. However, because the system has acquired data associated with the new channel via the second content delivery pathway, this data will have been processed and may be displayed to the user while the receiver is tuning, demodulating and decoding the data on the new channel received via the first content delivery pathway.

In one embodiment, the system may determine that a channel change operation is imminent by using an accelerometer positioned in a user interface device (e.g. remote control). In this embodiment, when the accelerometer detects movement of the user interface device, a signal may be communicated to the receiver that the user is planning to change the channel. Upon receipt of the signal that the user interface device is moving, the system may send a content request message via the second content delivery pathway to the content source to request the candidate set of channels be delivered to the receiver thereby advantageously reducing the time to display a newly selected channel via the second content delivery pathway before the receiver actually tunes to the newly selected content using the first content delivery pathway.

The system may intelligently identify which channels are to be included in the candidate set of channels requested when determining that a channel change is imminent. In one embodiment, the system may select candidate channels by including a predetermined number of channels above and below the currently tuned channel. This advantageously enables the system to process and display content on the immediately surrounding channels if the channel change operation is one of a channel up or channel down operation. The system may dynamically modify the requested set of candidate channels in response to continued user channel change operations. For example, if a user is currently displaying content provided on channel 7, the system may request the candidate set of channels include channels 4-6 and channels 8-10. These channels are received from the content source via the second bidirectional content delivery pathway until an actual channel selection is made by the user. This advantageously provides a likely set of channels, each with their own respective content, to the system in advance of an actual selection being made by the user. By preloading the receiver with the set of candidate channels, the system can substantially immediately display the content on any of the candidate channels should the user actually select a respective one of the candidate channels. This pre-loading enables the system to display content corresponding to the actual selection more quickly.

In another embodiment, the system may selectively modify the requested candidate channels in response to continued user selection. For example, if the user is using one of the channel up or channel down keys, the system may continually send out request messages requesting additional candidate channel sets based on the currently selected and tuned channel.

In a further embodiment, the system may select candidate channels using a predetermined set of channels based on user selection. In one example, the candidate channels requested may also include content on channels that the user has identified as a favorite. In another embodiment, the candidate channels requested may be based on a current viewing session whereby the system has detected a user viewing pattern over a predetermined amount of time and includes the channels that have been selected by the user during the predetermined amount of time. For example, if a user is continually changing between three channels over the prior ten minute period, the system advantageously detects which three channels and includes in the request for candidate channels, the content on those three channels.

The above exemplary embodiments identifying how candidate content is requested is described for purposes of example only. Any one of the embodiments or all of the embodiments may be implemented by the system thereby providing a comprehensive set of candidate content that may be requested when the system determines that the channel change operation is imminent.

The system advantageously provides a fine grain combination of broadcast and broadband networks wherein the benefit being that a fast broadband connection is faster than the broadcast tuner front end in providing feedback to the viewer resulting from channel changes. By detecting user activity at the user interface device, the receiver establishes a bidirectional communication link to a content provider server to request the candidate set of content therefrom. The candidate set of channels supplied via the second content delivery pathway preloads a decoder buffer with the content on those channels in the receiver in anticipation of channel changes. When a channel change operation is detected, buffered data can be decoded, or if not in the buffer, the candidate set of channels can be obtained on demand from a particular content provider server via the internet. This occurs because the pipeline latency of the broadband connection is less than the broadcast pipeline latency. The data on each respective one of the candidate set of channels may be transmitted via the broadband second content delivery pathway and received at a time prior to the receipt of the channel being tuned, received and decoded via the broadcast content delivery pathway content. Thus, the system advantageously provides faster feedback to the viewer by enabling a more seamless channel change operation.

The operation of the system is made possible by encoding data on each of the channels as separate data streams and generating a common global timestamp that is associated with and encoded in each stream. By having a global time stamp associated with each data stream for each channel, a receiver that has received each data stream at different points in time may compare the global timestamp in each stream to allow the receiver to seamlessly switch the display of the first data stream received via the second content delivery path to the second data stream received via the first content delivery pathway.

In another embodiment, the channel change operation can be further accelerated by using different encoding characteristics when encoding content for transmission via the first content delivery pathway as compared to the second content delivery pathway. An encoding characteristic may include any of (a) spatial resolution; (b) temporal resolution; (c) bitrate; (d) loss tolerance; (e) low latency; and (e) any other parameter controllable by a video encoder. In another embodiment, the encoding characteristic may be an audio encoding characteristic including but not limited to (a) monaural encoding; (b) multichannel encoding; (c) audio bitrate; and (c) sample rate. For example, the content encoded for broadcast via the first content delivery pathway may be encoded at a higher resolution as compared to the content encoded for transmission via the second content delivery pathway. In one embodiment, the content encoded for transmission via the second content delivery pathway may use a low-latency codec. Thus, when the receiver detects that a channel change operation is imminent and requests a set of candidate channels from the content provider server, the data on each respective channel in the requested set of candidate channels may be encoded at a lower resolution. This enables faster processing by the receiver for displaying data on the channel to the user with minimal visual difference to the user. This lower resolution content will be displayed until the receiver, using the global time stamp associated with the data received by each of the first and second content delivery pathways, determines that a switchover from the lower resolution content received via the second content delivery pathway to the desired resolution content via the first content delivery pathway can occur. This advantageously allows the viewer to view data when changing the channels much faster than waiting for the receiver to fully demodulate and decode the broadcast content received via the first content delivery pathway. The present system will be particularly useful in a content delivery scheme wherein data is compressed and transmitted using higher compression codecs by higher bit rate modems, since it is likely that these methods will further increase latency, and consequently, channel change time. The combination of a channel-change assist by a broadband network plus a higher capacity and higher compression broadcast standard advantageously produces the inventive hybrid broadcast service.

Furthermore, an additional advantage provided by the present system relates to the robustness of the content delivery. The second content delivery pathway enables the receiver to fall back to content being delivered thereon in response to detection of an outage or interruption (e.g. severe multipath fading or impulse noise) of the content received via the first content delivery pathway.

Once the receiver has begun displaying the content received by the second content delivery pathway and has detected that the same content, at the same point in time has been tuned and decoded on the first content delivery pathway based on a global timestamp comparison, the receiver may synchronize the data streams. The receiver may automatically switch the source from which the content is being displayed from the low latency content data provided via the second content delivery pathway to the content being provided by the first content delivery pathway.

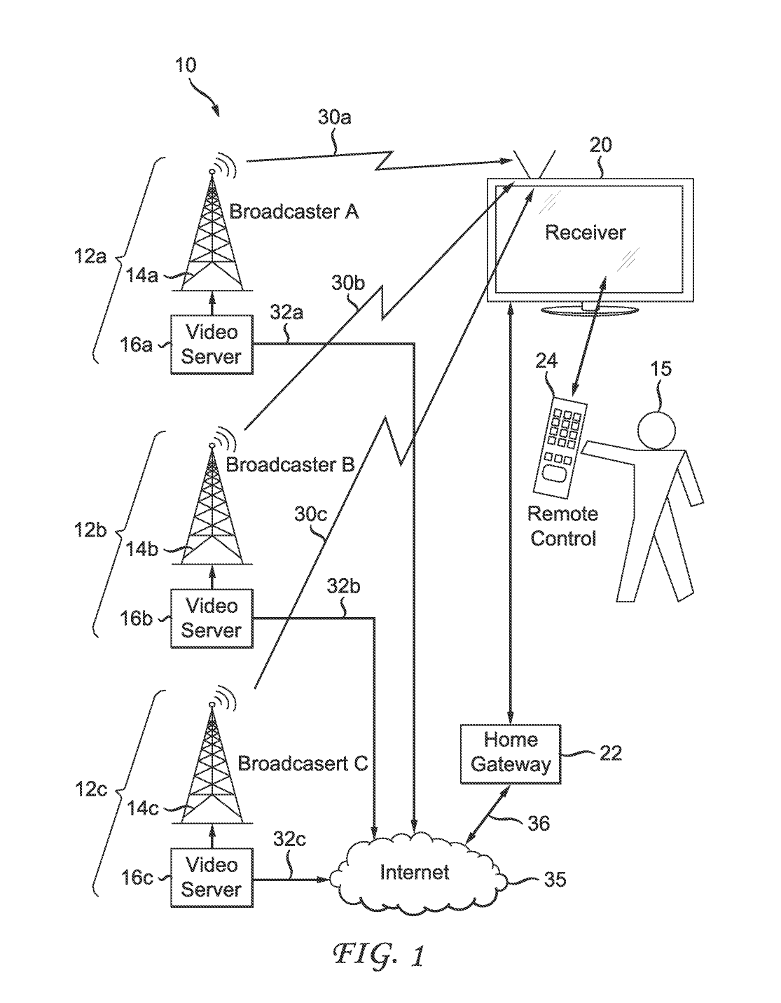

FIG. 1 is an illustrative view of the broadband channel assist system 10 according to invention principles. The system 10 is deployable in an environment whereby at least one user 15 selectively receives content data transmitted on at least one channel from at least one content provider 12. The depiction of a single user 15 is shown for purposes of example only and one skilled in the art of content distribution systems and networks will understand that a plurality of different users are connected to various content providers 12 enabling direct delivery of user selected content on different channels. The at least one user includes a receiver 20 for selectively receiving channels containing content from a content provider 12 and a gateway device 22 selectively coupling the receiver 20 to a wide area network (e.g. the internet).

As shown herein the present system includes a plurality of content providers referred to generically by reference numeral 12. As used herein, a content provider may produce, generate, aggregate or otherwise acquire and transmit data representing audiovisual content on one or more channels to the at least one user 15. In one embodiment, a content provider may be a television station that transmits television shows (e.g. content data) on particular channel (e.g. frequency) to users for viewing on a home display device. In another embodiment, the content provider may be a satellite or cable system that aggregates a plurality of different types of content generated or produced from various sources and distributes the aggregated content on one or more channels to the at least one user 15.

The system includes a first content provider 12a, a second content provider 12b and a third content provider 12c. The number of content providers 12 shown herein should not be construed as limiting and any number of content providers may be included in the system 10. The depiction of three content providers 12a, 12b and 12c are for illustrative purposes to facilitate ease of understanding of system operation. Each respective content provider 12a, 12b and 12c include a first transmission interface 14a, 14b, 14c, respectively. The first transmission interfaces 14a, 14b, 14c transmit content data on respective channels via a first content delivery pathway 30a, 30b, 30c. In one embodiment, the first content delivery pathways 30a, 30b, 30c are broadcast pathways whereby content data is broadcast on a respective RF channel to the at least one user 15 via the respective first transmission interfaces 14a, 14b, 14c. The first content delivery pathway 30a, 30b 30c being described as a RF broadcast transmission pathway is for purpose of example only and the first content delivery pathway may be any type of unidirectional communication pathway that enables transmission of content data on one or more channels from an individual content provider to a plurality of different users. The first content delivery pathway may be limited to users within a particular geographic region or may be limited to users that have predefined agreement between provider and user (e.g. a subscriber agreement).

Each respective content provider 12a, 12b and 12c includes a second transmission interface 16a, 16b, 16c, respectively. The second transmission interfaces 16a, 16b, 16c transmit the content data associated with the same channels transmitted using the first transmission interface 14a, 14b, 14c but instead use a second content delivery pathway 32a, 32b, 32c. The content delivered by the second content delivery pathway is identical to the content transmitted via the first content delivery pathway but formatted (e.g encoded) in such a manner to allow for quicker processing of this content by a receiver. In one example, the first content delivery pathway is an RF broadcast system delivering High Definition (HD) content and the second content delivery pathway is a cable system delivering Standard Definition (SD) content. The content transmitted via the second content delivery pathway may be processed and displayed by the receiver in less time than it takes to acquire and display the content transmitted via the first content delivery pathway. In one embodiment, the second transmission interface 16a, 16b, 16c may be a streaming interface that selectively streams data formatted for transmission over a broadband or other IP based network such as the internet 35. The description of the second transmission interface 16a, 16b, 16c being described as a streaming interface and the second content delivery pathway being described as a broadband/IP-based network is for purposes of example only and the second content delivery pathway may be any type of communication network enabling bidirectional communication between the at least one user 15 and the second transmission interface 16a, 16b, 16c of the content provider 12a, 12b, 12c.

In exemplary operation, the at least one user 15 uses an interface device 24 (shown here as a remote control) to control the receiver 20 to select a channel and acquire content transmitted on the selected channel from a content provider 12. Upon initial selection of content via the user interface device 24, the receiver 20 tunes to a channel on which the selected content is being transmitted. The selected content is transmitted from the respective content provider 12a, 12b, 12c on its respective channel via the first content delivery pathway 30a, 30b, 30c for receipt by the receiver 20.

Should the user wish to change the content being viewed, the receiver 20 selectively detects that a channel change request is imminent in response to user interaction with the user interface device 24. Upon detecting that a content change request is imminent, the receiver 20 generates a request for a set of candidate channels each having content associated therewith to be acquired from content providers 12a, 12b, 12c. The receiver 20 provides the request for the set of candidate content to a gateway 22 device via an internal communications network 34 (e.g. Local area network, Coaxial cable, MoCA, etc). The gateway device 22 controls bidirectional communication between the at least one user 15 and a wide area network 35 such as the internet via connection 36. The gateway device 22 routes the request for the set of candidate channels to the correct content provider 12a, 12b, 12c and facilitates acquisition of the set of candidate channels and data associated with the channels via the second transmission interface 16a, 16b, 16c of the respective content provider 12a, 12b, 12c. Once the receiver 20 has received and processed the channel change operation and the new channel is selected, the receiver performs two functions simultaneously. The receiver 20 tunes to the newly selected channel and acquires data on the newly selected channel via the first content delivery pathway. The receiver 20 also automatically selects the content associated with the newly selected channel from the set of candidate channels received via the second content delivery pathway. The data transmitted on the second content delivery pathway is formatted such that the receiver selectively processes and displays the data in an amount of time less than it takes for the receiver to tune and decode the same content data transmitted via the first content delivery pathway. Thus, the user is presented with content data substantially immediately while the tuner in the receiver tunes to the selected channel and data from the selected channel is decoded.

The receiver 20 may compare a global timestamp associated with the content data transmitted via the first content delivery pathway and the global timestamp associated with the content data transmitted via the second content delivery pathway to determine whether these timestamps match. Once a match point is identified, the receiver may switch the source of the content data being displayed to a user from the second content delivery pathway to the first delivery pathway.

In this system, each content provider 12a, 12b, 12c is responsible to provide the data to accelerate the transition to any of their respective channels. Failure to encode and transmit content data via the second content delivery pathway would make changing an RF channel a slower process than changing to other channels in which content providers have implemented this hybrid content delivery system.

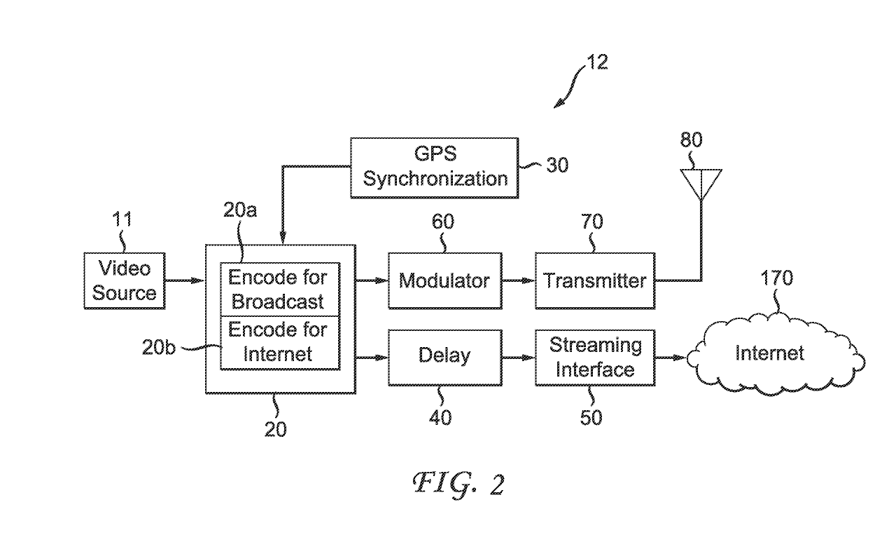

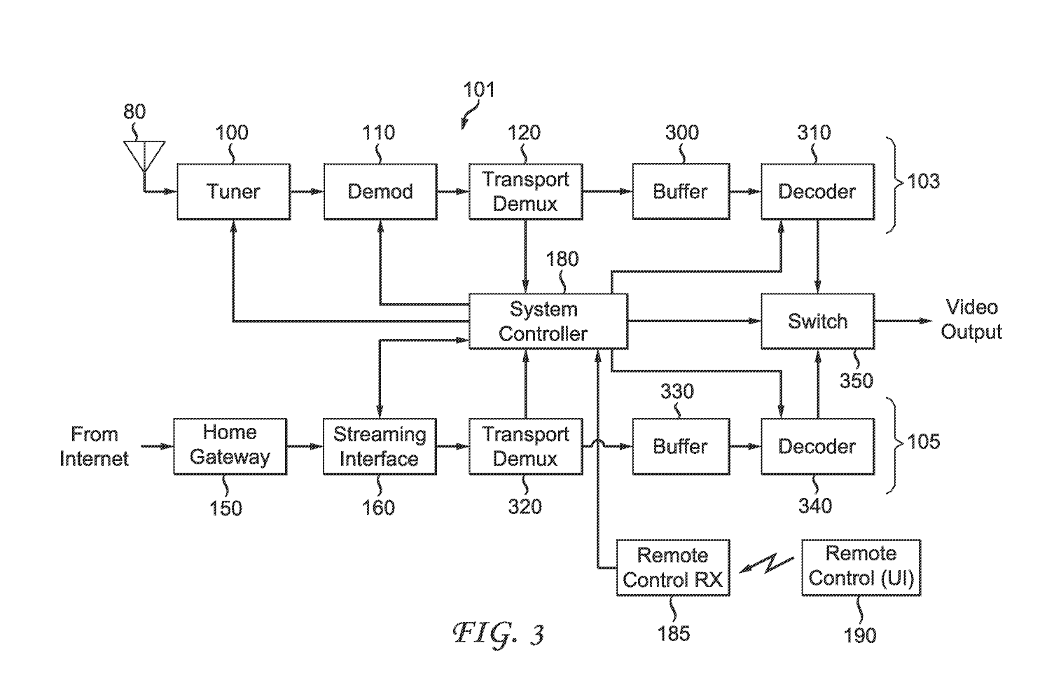

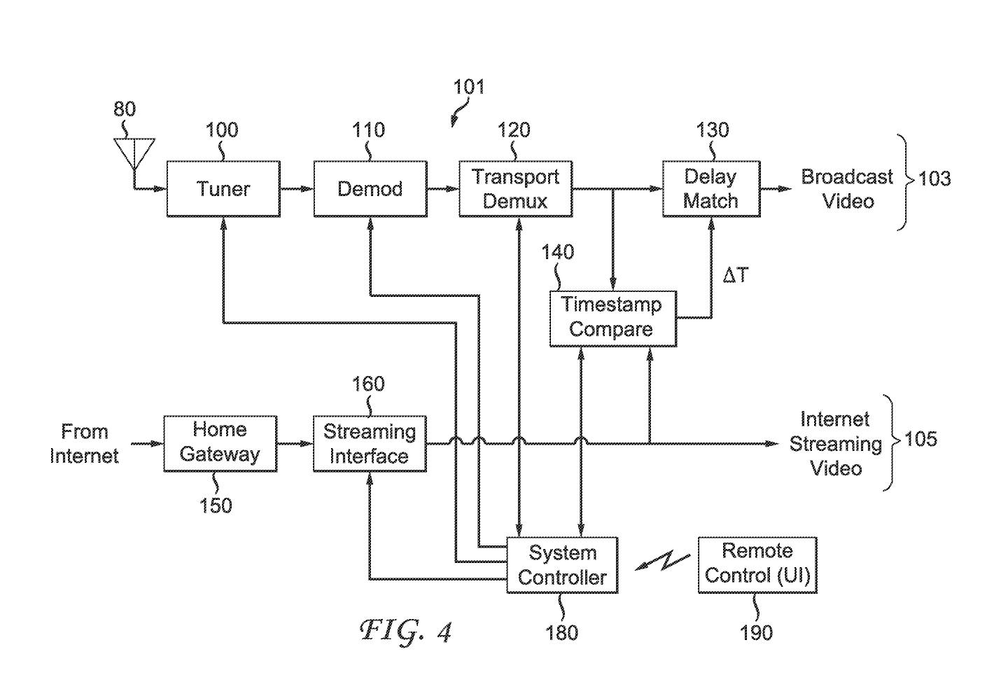

FIG. 2 is a block diagram of an exemplary content provider 12 for selectively providing content on one or more channels to at least one user. The content provider 12 includes at least one data source 11 for providing audiovisual content data to the at least one user. The source 11 is electrically coupled to an encoder 20 and provides content data to the encoder 20 for encoding according to at least one type of encoding scheme. The encoder 20 may include a first encoding module 20a that encodes content data according to a first encoding scheme. (e.g. broadcast encoding). The encoder 20 may further include a second encoding module 20b that encodes the content data acquired from the video source 11 according to a second encoding scheme. (e.g. Internet Protocol encoding). The first and second encoding modules 20a and 20b encode the same content data at the same time. As part of the encoding process, the encoder encodes with the content data, data representing the channel on which the encoded content is to be transmitted thereby enabling a receiver to use a channel map to understand where and how the encoded data stream is to be decoded as will be discussed hereinafter with respect to FIGS. 3 and 4.

In one embodiment, the first encoding module 20a selectively encodes content data according to a broadcast data format using a broadcast encoding algorithm. By encoding content data using the broadcast data format, the content provider 11 may selectively broadcast the encoded content data on a particular channel (e.g. frequency) for receipt by a plurality of users. In this embodiment, the second encoding module 20b may selectively encode the content data from the video source 11 using a broadband data format using a broadband encoding algorithm. By using the broadband encoding algorithm, the content data encoded via the second encoding module 20b may be selectively transmitted to a plurality of users via a wide area broadband network (e.g. the internet).

In another embodiment, the content data encoded by the first encoding module 20a is encoded using at least one different encoding characteristic as compared to the content data encoded by the second encoding module 20b. The difference in encoding characteristics enables the content data encoded by one of the encoding modules 20a, 20b to be processed by a receiver for display quicker than the content data encoded by the other of the encoding modules 20a, 20b. For example, the content data encoded by the first encoding module 20a may be encoded using an encoding algorithm that includes all desired encoding characteristics whereas the content data encoded by the second encoding module 20b is encoded using an encoding algorithm that includes at least one less encoding characteristic thereby resulting in the content data encoded by the second encoding module 20b being of a lesser quality. One example is HD encoded content versus SD encoded content. Thus, the content data encoded by the second encoding module 20b may be processed more quickly for display to a user. This, as will be discussed below, results in the advantageous presentation of newly selected content to a user more quickly than typically provided in a system employing a single content delivery pathway.

The content provider 12 further includes a timestamp generator 30 for generating a common global timestamp that will be associated and encoded with the content data from the video source 11. The global timestamp generated by the timestamp generator 30 provides a stable time reference for the transmission system. Furthermore, as will be discussed below with respect to FIGS. 3 and 4, the global timestamp advantageously enables the receiver to synchronize the content data delivered via the first and second delivery pathways to enable the receiver to switch from displaying content from one of the delivery pathways to the other delivery pathway.

The first encoding module 20a is associated with and provides encoded content data for transmission via the first content delivery pathway. The content data encoded by the first encoding module 20 is provided to a modulator 60 that modulates the encoded content data for RF broadcast. In one embodiment, the modulator 60 modulates the encoded content using an 8-VSB or any other broadcast modulation process that is known to persons skilled in the art. The modulated encoded content data is provided to a transmitter 70 which transmits the modulated encoded content data on a particular channel 80 as is known in the art.

The second encoding module 20b is associated with and provides encoded content data for transmission via the second content delivery pathway. Upon encoding according to the second encoding scheme, a delay is introduced via a delay module 40. The delay module 40 allows the content data transmitted on the second content delivery pathway to be delayed in the receiver to match the delay associated with the second content delivery pathway. The delay module 40 inserts a delay of a predetermined amount of time to insure that the delay in the second content delivery pathway exceeds any delay associated with the first content delivery pathway and allows the receiver to equalize the delays on the first content delivery pathway using a delay matching buffer as discussed in FIGS. 3 and 4.

Once the delay is introduced, the content data encoded by the second encoding module 20b is provided to a transmission interface 50. The transmission interface 50 enables transmission of the content data via the second content delivery pathway. The transmission interface 50 is coupled to a wide area network 170 and enables transmission via the transmission interface 50 of the content provider 12 to a requesting user. Additionally, the transmission interface 50 is able to selectively receive at least one user request for particular content data associated with a particular channel. By receiving requests from users, the transmission interface 50 is able to provide to the user content data associated with particular channels thereby enabling the user to receive and process content data in an amount of time less than it takes to tune and receive content data via the first content delivery pathway. In one embodiment, the transmission interface 50 is a streaming interface that selectively streams content data from the content provider to the requesting user via the wide area network 170.

FIG. 3 is an exemplary block diagram of a receiver 101. The receiver 101 selectively decodes content data received via the first content delivery pathway and the second content delivery pathway. The receiver 101 includes a system controller 180 that selectively controls the operation of the decoding modules 103 used for decoding content delivered via the first content delivery pathway. Controller 180 also controls the decoding modules 105 used for decoding content delivered via the second content delivery pathway.

The decoding modules 103 for decoding and processing content data received via the first content delivery pathway includes a channel 80 that is selectively controlled by a tuner 100 to receive content data transmitted on a particular channel frequency. A demodulator 110 selectively recovers digital data from the signal received by the channel 80 and a transport demultiplexer 120 selects, from the recovered digital data, a particular data stream to be processed. The data stream selected by the transport demultiplexer 120 is fed into a buffer 300 until a predetermined buffer level is met to allow enough data to be present to enable decoding by a first decoder 310 for output to a display device. The first content delivery decoding modules 103 are engaged in response to the system controller 180 receiving a stimulus from a user interface device indicating that the tuner 100 should be tuned to a different channel 80 to acquire content data associated with a new channel.

The decoding modules 105 for decoding and processing content data received via the second content delivery pathway includes a streaming interface 160 coupled to the system controller 180. The streaming interface 160 is further coupled to a gateway device 150 that selectively governs and controls access to the second content delivery pathway which may be a wide area network (e.g. internet). A data stream transmitted via the second content delivery pathway is received by the gateway 150 and provided to the streaming interface 160. A second transport demultiplexer 320 is coupled to the streaming interface 160 and selectively chooses at least one data stream representing content data on at least one channel to be decoded. The at least one data stream is provided to a buffer 330 and is decoded by a second decoder 340.

A switch 350 is coupled between the first decoder 310, second decoder 340 and the system controller 180. The switch 350 is selectively controlled by the system controller 180 to choose the source of the decoded video data to be output to the user.

The receiver 101 may also include a remote control receiver 185 also coupled to the system controller 180. The remote control receiver 185 selectively receives stimulus from a remote control 190 (e.g. user interface device). The remote control 190 may provide a first control message that causes the receiver to act in a certain manner. For example, the first control message may include any of a channel change request, activation of a program guide, scrolling through a program guide, request for additional program information, etc. In short, the first control message may be any request to engage or disengage any system feature. The remote control 190 may also provide a second control message for receipt by the remote control receiver 185. The second control message may be generated by a component in the remote control 190 and be indicative of an imminent channel change. The system controller 180, upon receipt of the second control message, selectively controls the streaming interface 160 to request content data associated with a candidate set of channels via the second content delivery pathway. This enables the receiver to pre-fetch possible sources of content data in advance of an actual selection of a new source of content data thereby allowing the receiver 101 to process and display newly selected content prior to tuning to the newly selected content via the first content delivery pathway.

In one embodiment, the second control message generated by the remote control 190 may be generated in response to sensing of movement thereof by an accelerometer in the remote control 190. For example, an accelerometer may determine that a user has picked up and moved the remote control 190 which may be indicative of the user's desire to change the channel. The accelerometer may generate and provide the second control message to the receiver 101 causing the receiver 101 to engage the second content delivery pathway decoders 105 as discussed above.

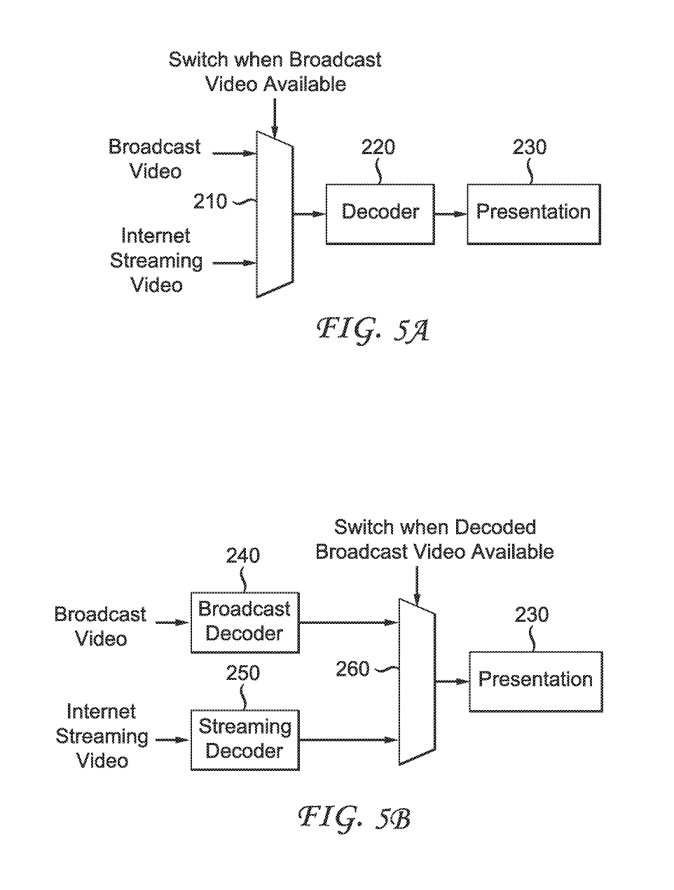

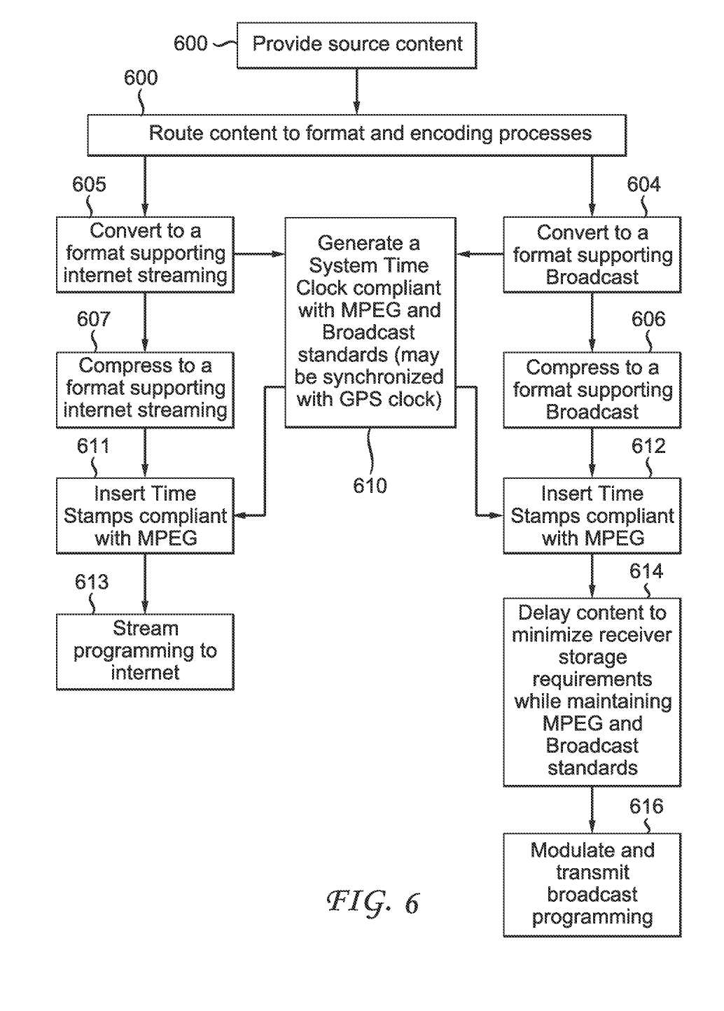

FIG. 4 is an alternate embodiment of a receiver 101. FIG. 4 includes certain similarly labeled components as those described above in FIG. 3, the discussion of which will not be repeated herein. The primary difference between the receivers of FIG. 3 and FIG. 4 is associated with the first content delivery pathway decoding modules 103. As shown herein, and in contrast to FIG. 3, the first content delivery pathway decoding modules 103 includes a delay match module 130. The delay match module 130 matches the content data received and processed by the second content delivery pathway decoding modules 105 to the decoder for the first content delivery pathway decoding modules 103. The delay match module 130 advantageously compensates for any decoding delays in a system with separate broadcast and broadband decoders (see FIGS. 5A and 5B) to ensure a smooth transition between the content data received via the second content delivery pathway decoding modules 105 and the first content delivery pathway decoding modules 103. There is a fairly large variable delay in the second content delivery pathway decoding modules 105 (see delay module 40 in FIG. 2). To compensate for this, delay module 40 (FIG. 2) is included to make the second content delivery pathway decoding modules delay longer than the first content delivery pathway decoding modules delay. In the receiver, delay module 130 matches the second content delivery pathway decoding modules delay to enable smooth transition from the second content delivery pathway that provides content data during a channel-change operation to the content data that is tuned, demodulated and decoded via the first content delivery pathway via decoding modules 103.

The receiver 101 further includes a timestamp comparison module 140. The timestamp comparison module 140 is selectively coupled to both the first content delivery pathway decoding modules 103 and the second content delivery pathway decoding modules 105 and analyzes the global timestamp associated with data stream on each pathway. The timestamp comparison module 140 determines the delay between the data stream received via the first content delivery pathway decoding modules 103 and the data stream received via the second content delivery pathway decoding modules 105. This delay data is provided to the delay match module 130 to synchronize the data streams to enable the smooth transition for content received from the second content delivery pathway to the first content delivery pathway.

FIGS. 5A and 5B provide alternate embodiments for decoders that may be implemented in the receivers as shown in FIGS. 3 and 4. In FIG. 5A, a source multiplexer 210 is provided and receives data streams from the first content delivery pathway decoding modules 103 and the second content delivery pathway decoding modules 105. The source multiplexer 210 provides the data stream received via the second content delivery pathway decoding modules 105 to a single decoder 220 which decodes the data stream and outputs the decoded data to a presentation device 230 (e.g. TV, HDTV, etc). The system controller (180 in FIGS. 3/4) selectively controls the source multiplexer 210 to switch its output to be the data stream acquired via the first content delivery pathway decoding modules 103 when the system controller determines that the data stream is available to enable decoding of that data stream by decoder 220.

In FIG. 5B, the receiver includes a first decoder 240 that is connected to the first content delivery pathway decoding modules 103 and a second decoder 250 that is connected to the second content delivery pathway decoding modules 105. The first and second decoders 240 and 250 selectively decode data streams received via their respectively associated delivery pathways. A decoder output multiplexer 260 is coupled to each of the first decoder 240 and the second decoder 250. The decoder output multiplexer 260 is further connected to a presentation device 230 and controls the source of the data to be presented on the presentation device 230. The system controller 180 selectively controls the output multiplexer to use the decoded data received via the second content delivery pathway until such a time it is determined that the data stream from the first content delivery pathway is available.

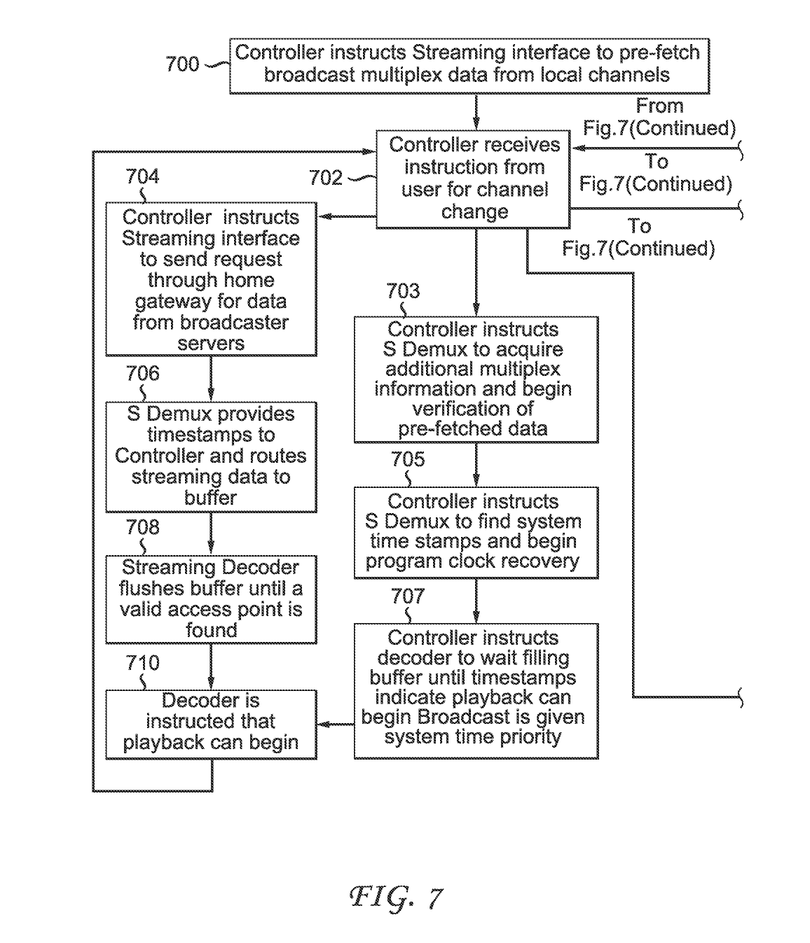

FIG. 6 is a flow diagram detailing exemplary operation of the encoding process performed by a content provider as shown in FIG. 2. In block 600, a source of content data is provided and in block 602, the content data is routed to the encoder for formatting and processing. The encoder may perform two encoding processes simultaneously using separate encoding modules and each encoding process will be discussed individually. In block 604, the content data is converted to a first content format suitable for transmission via the first content delivery pathway. In one embodiment, the conversion in block 604 is to a format that supports broadcast transmission by a broadcaster. In block 606, the converted data is compressed using a compression algorithm suitable for transmission via the first content delivery pathway. In one embodiment, the compression algorithm is an MPEG compliant compression algorithm.

In block 610, a global timestamp is generated by a timestamp generator and the generated timestamp is inserted into the compressed content data in block 612. A delay is added to the compressed content data for transmission via the first content pathway in block 614. The delay advantageously minimizes an amount of storage in a receiver while maintaining compliance with any and all format and broadcasting standards. Thereafter, in block 616, the data stream is modulated and transmitted via the first content delivery pathway.

Simultaneously, the encoder employs a second encoding module to encode the content data in a different format suitable for transmission via the second content delivery pathway. In block 605, the second encoding module converts the content data into a format suitable for transmission via the second content delivery pathway. In one embodiment, the format is an internet streaming format. In block 607, the second encoding module compresses the formatted data using a compression standard compliant with the second content delivery pathway. In one embodiment, the compression standard used is a compression standard compliant with an internet streaming format. In block 610, the global timestamp is generated by a timestamp generator and the generated timestamp is inserted into the compressed content data formatted for transmission via the second content delivery pathway in block 611. Thereafter, in block 613, the content data formatted for transmission via the second content delivery pathway is provided to a transmission interface for transmission via the second content delivery pathway.

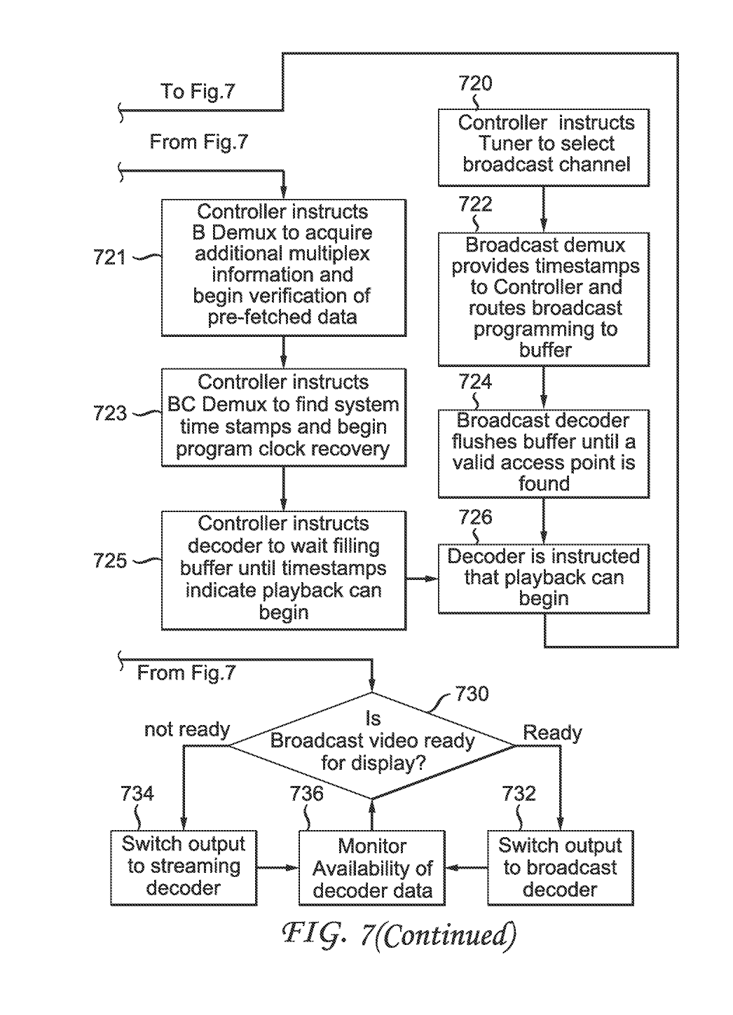

FIG. 7 is a flow diagram detailing exemplary operation of the receiver that selectively receives content data on respective channels via the first and second content delivery pathways. In block 700, the system controller instructs the streaming interface to pre-fetch a set of candidate channels each having respective content transmitted thereon. Block 700 may be triggered, for example, in response to the system controller detecting that a channel change is imminent based on movement sensed by an accelerometer in a remote control device. The data requested in block 700 is acquired via the second content delivery pathway and may include content data that is formatted to enable quicker processing and display thereof For example, the pre-fetched data may be formatted as lesser quality data as compared to the data received via the first content delivery pathway (e.g. lower resolution, lower bitrate, less loss tolerance, etc).

In block 702, the system controller receives a stimulus from a remote control indicating a channel change operation has been requested. In response to a channel change request, the system controller initiates two concurrent processes that result in the display of the content data on the newly selected channel. While the two processes will be discussed individually, it is important to note they occur substantially simultaneously and enable a quicker presentation of the requested content to a user.

The first process relates to the acquisition of content data associated with the newly selected channel via the second content delivery pathway. In block 704, the controller instructs a streaming interface to send a request via the home gateway for a candidate set of channels. The streaming interface receives data corresponding to the candidate set of channels and timestamps associated with the content data on each channel are provided to the controller in block 706. The received content data on the candidate channels is provided to the buffer and, in block 708, the buffer is flushed until a valid access point is found. In the event that multiple candidate channels are received, the system may include buffers for each channel or may include a single partionable buffer to allow for storage of content data for all channels thereby allowing the receiver to have access to different sets of content data that may be selected by the user. In block 710, once the valid access point is located, the decoder is instructed that playback can begin.

Referring back to block 702 wherein a channel change request has been registered, the controller, in block 703, further acquires additional multiplex information and begins verification of the data that was prefetched in block 700. In block 705, the controller acquires the system time via the timestamp encoded in the content data and begins the clock recovery process. The controller instructs the decoder to wait until the recovered timestamp indicates that playback can begin in block 707. Once playback can begin, the system in block 710 instructs the decoder that playback can begin.

Referring again back to block 702, the controller, upon detecting a channel change request, causes the tuner to tune to the selected channel for receipt via the first content delivery pathway in block 720. In block 722, the timestamps associated with the content received via the first content delivery pathway are acquired and the content data is routed to a programming buffer. The first content delivery pathway decoder flushes the buffer until a valid access point is located in block 724 and the decoder is instructed that playback of the content acquired via the first content delivery pathway can begin in block 726.

Additionally, in block 721, the controller further acquires additional multiplex information and begins verification of the data that was prefetched in block 700. In block 723, the controller acquires the system time via the timestamp encoded in the content data and begins the clock recovery process. The controller instructs the decoder to wait until the recovered timestamp indicates that playback can begin in block 725. Once the recovered timestamp indicates playback can begin, the system in block 710 instructs the decoder that playback can begin.

In block 730, the system controller queries whether or not content data acquired via the first content delivery pathway is ready for display. This query occurs immediately upon registering a request for a channel change in block 702. If the system controller determines that content data on the newly selected channel is not available from the first content delivery pathway, the controller switches to the decoder associated with the second content delivery pathway for output to a display device. The system controller monitors the availability of the decoder data in the decoders associated with the first and second content delivery pathways in block 736 and, after a predetermined period of time, re-queries, in block 730, whether content data acquired via the first content delivery pathway is available for display. If the answer to the query in block 730 is positive, the controller switches to the decoder associated with the first content delivery pathway in block 732 and continues to monitor availability of decoder data in block 736.

The above described system advantageously provides a receiver with the ability to intelligently pre-fetch content data transmitted on channels that are likely to be selected by a user in a channel change operation. The pre-fetched content data is acquired via a second content delivery pathway in advance of a channel change operation to pre-populate buffers with content data on channels likely to be selected by a user. The pre-fetched content data is advantageously formatted in such a manner to allow for quicker processing, decoding and presentation to a user while the receiver tunes to a newly selected channel for receipt via the first content delivery pathway. Because there is a time lag in tuning, demodulating and decoding content data on a channel, there is no video data typically provided to the user during this process. However, by pre-fetching content data formatted to allow for quicker processing, the receiver may be able to minimize an amount of time where no video data is shown to the user thereby improving the viewing experience. The user is presented with content data while the tuner is actually tuning to the selected channel. Thus, the user experience is enhanced because the present system improves the speed at which a new channel is tuned but does this by acquiring the same data via a second content delivery pathway in such a manner that is not obvious to the user and does not degrade system performance.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

1. A receiver for reducing a time delay associated with a change between two channels of a plurality of channels, the receiver comprising:
a tuner coupled to a first content delivery pathway for selectively tuning to a particular channel of said plurality of channels having content data transmitted thereon;
a transmission interface coupled to a second content delivery pathway for selectively acquiring content data from a set of candidate channels from amongst said plurality of channels, the content data from the set of candidate channels being acquired in advance of a channel change operation;
a decoder coupled to the tuner and the transmission interface for decoding content data received via the first content delivery pathway and content data received via the second content delivery pathway; and
a controller that, in response to detecting an activity associated with a channel change operation to select a new channel, requests the content data associated with the set of candidate channels from at least one content provider via the transmission interface.

2. The receiver of claim 1, wherein
upon detection of a request to change a channel, the controller simultaneously:
controls the tuner to tune to the requested channel and acquire content data from the at least one content provider via the first content delivery pathway for decoding by the decoder, and
controls the decoder to decode acquired content data associated with the requested channel on a respective one of the candidate channels corresponding to the requested channel received via the second content delivery pathway and display the decoded content data until the tuner tunes to the requested channel.

3. The receiver of claim 1, wherein
the controller compares a time stamp associated with the content data of the requested channel received via the first content delivery pathway with a time stamp associated with the content data of the requested channel received via the second content delivery pathway.

4. The receiver of claim 1, further comprising
a switch selectively controlled by the controller to select a source of the content data for display on a display device, the source being one of the first content delivery pathway and the second content delivery pathway.

5. The receiver of claim 1, wherein
the content data received via the first content delivery pathway is formatted according to a first content format and the content data received via the second content delivery is formatted according to a second content format.

6. The receiver of claim 1, wherein
the first content format is different from the second content format.

7. The receiver of claim 1, wherein
the first content delivery pathway is a unidirectional transmission pathway.

8. The receiver of claim 1, wherein
the second content delivery pathway is a bidirectional pathway.

9. The receiver of claim 1, wherein
the activity associated with a channel change operation is detected by the controller and is in response to receipt of a control signal indicative of a movement of a user interface device.

10. The receiver of claim 1, wherein
the set of candidate channels includes at least one of:
a. a predetermined number of channels surrounding a channel currently tuned by the tuner,
b. channels indicated by a user as favorite channels,
c. based on characteristics of an active viewing session; and
d. based on viewing habits of the user.

11. A method of reducing a time delay associated with a change between channels of a plurality of channels in a receiver, the method comprising the activities of:
providing a tuner coupled to a first content delivery pathway for selectively tuning to a particular channel of said plurality of channels having content data transmitted thereon;
acquiring, in advance of a channel change operation, content data from a set of candidate channels from amongst said plurality of channels via a transmission interface coupled to a second content delivery pathway;
detecting an activity associated with a channel change operation by a controller; and
requesting content data associated with the set of candidate channels from at least one content provider via the transmission interface.

12. The method of claim 11, further comprising the activity of
detecting a channel change request and simultaneously:
controlling the tuner to tune to the requested channel and acquire content data from the at least one content provider via the first content delivery pathway for decoding by the decoder, and
controlling the decoder to decode acquired content data associated with the requested channel on a respective one of the candidate channels corresponding to the requested channel received via the second content delivery pathway; and
displaying the decoded content data until the tuner tunes the requested channel.

13. The method of claim 11, further comprising;
comparing, by the controller, a time stamp associated with the content data of the requested channel received via the first content delivery pathway with a time stamp associated with the content data of the requested channel received via the second content delivery pathway.

14. The method of claim 11, further comprising
switching to select a source of the content data for display on a display device, the source being one of the first content delivery pathway and the second content delivery pathway.

15. The method of claim 11, wherein
the content data received via the first content delivery pathway is formatted according to a first content format and the content data received via the second content delivery is formatted according to a second content format.

16. The method of claim 15, wherein
the first content format is different from the second content format.

17. The method of claim 11, wherein
the first content delivery pathway is a unidirectional transmission pathway.

18. The method of claim 1, wherein
The second content delivery pathway is a bidirectional pathway.

19. The method of claim 11, wherein
the activity associated with a channel change operation is detected by the controller is in response to receipt of a control signal indicative of a movement of a user interface device.

20. The method of claim 11, further comprising
selecting the set of candidate channels by at least one of:
a. a predetermined number of channels surrounding a channel currently tuned by the tuner,
b. channels indicated by a user as favorite channels,
c. based on characteristics of an active viewing session; and
d. based on viewing habits of the user.
